(19) United States
(12) Patent Application Publication
(10) Pub. No.: US 2022/0190671 A1
(43) Pub. Date: Jun. 16, 2022

(54) End Shield for an Electric Rotating Machine, Use Thereof, and Electric Rotating Machine

(71) Applicant: Siemens Aktiengesellschaft, München (DE)

(72) Inventors: David Finck, Forchheim (DE); Martin Johannes, Erlangen (DE); Felix Ntourmas, Erlangen (DE); Christian Seidel, Baiersdorf (DE)

(73) Assignee: Siemens Aktiengesellschaft, München (DE)

(21) Appl. No.: 17/598,446

(22) PCT Filed: Mar. 16, 2020
(86) PCT No.: PCT/EP2020/057065

§ 371 Date: Sep. 27, 2021

(30) Foreign Application Priority Data
Mar. 29, 2019 (DE) 10 2019 204 456.5

(51) Int. Cl. H02K 5/15

(52) U.S. Cl. CPC H02K 5/15

(57) ABSTRACT

Various embodiments of the teachings herein include an end plate comprising: a device for receiving a bearing internally with an inner fastening circle; and fasteners for fastening the end plate to the housing of the electric machine externally with an outer fastening circle. The end plate has a geometry suitable for counteracting the deformation of the first natural frequency overcoming a flat and/or planar shape, or side, respectively, of the end plate by bending the end plate, with the same or a reduced mass and/or wall thickness of the end plate.

### CROSS-REFERENCE TO RELATED APPLICATIONS

This application is a U.S. National Stage Application of International Application No. PCT/EP2020/057065 filed Mar. 16, 2020, which designates the United States of America, and claims priority to DE Application No. 10 2019 204 456.5 filed Mar. 29, 2019, the contents of which are hereby incorporated by reference in their entirety.

### TECHNICAL FIELD

The present disclosure relates to motors. Various embodiments include end plates for motors and/or electric rotating machines such as electric motors and/or generators with improved stiffness.

### BACKGROUND

An end plate connects the housing of an electric motor to the mount for the rotating rotor. Typically, there are two end plates on an electric motor, since the shaft is supported at two points. A first end plate of an electric motor or generator carries a floating bearing, which does not, as a rule, withstand any axial forces, and a second end plate carries the fixed bearing. The fixed bearing absorbs forces that act in the axial direction and the associated end plate is designed and constructed in a correspondingly sturdy manner.

This second end plate of the fixed bearing is the component via which the significant mass of the motor is attached to the housing. The entire rotor region can vibrate in the axial direction, wherein the end plate acts as it were as a spring. The end plate is therefore constructed and designed to be as stiff as possible in order to keep the first natural frequency of the motor as high as possible. The first natural frequency of the motor is therefore prevented from dropping into the speed range of the motor. In common 3000 rpm machines, for example, the natural frequency lower limit is 50 Hz without including any safety measures.

An end plate is typically configured in a flat and stiff manner, with corresponding bores for fixing. FIG. 1 shows an end plate according to the prior art. A problem with a common end plate, as shown in FIG. 1, is that the stiffness is achieved via the mass, wherein particularly heavy and thick end plates simply have greater bending stiffness. A thicker end plate, by contrast, in turn demands longer screws. From a certain point, the weakest point of the end plate moves to the screw connections. Therefore, there is an expedient upper limit for the thickness of an end plate.

### SUMMARY

The teachings of the present disclosure include a design for such an end plate which provides greater stiffness of the end plate with an identical mass. For example, some embodiments include an end plate (1) for a housing of a rotating electric machine, having a device for receiving a bearing internally with an inner fastening circle (6), and means for fastening the end plate to the housing of the electric machine externally with an outer fastening circle (7), wherein the end plate has a geometry that is suitable for counteracting the deformation of the first natural frequency, because it overcomes the known flat and/or planar shape, or side, respectively, of the end plate by bending the end plate, in particular with the same or even a reduced mass and/or wall thickness of the end plate.

In some embodiments, the inner fastening circle (6) and outer fastening circle (7) have been displaced axially with respect to one another.

In some embodiments, the end plate is conical.

In some embodiments, the end plate has ribbing at least on one side.

In some embodiments, the end plate is made of a metal and/or a metal alloy.

In some embodiments, the end plate is made of a fiber-reinforced material.

In some embodiments, the end plate comprises a ceramic matrix.

In some embodiments, the fiber-reinforced material comprises a metal matrix.

In some embodiments, the fiber-reinforced material comprises a polymer matrix.

In some embodiments, the end plate has ribbing at least on one side or on both sides, said ribbing extending from the outer fastening ring to the inner fastening ring.

In some embodiments, the end plate has ribbing that partially has mutual cross-connections.

In some embodiments, the end plate has ribbing with webs that have different masses.

In some embodiments, the end plate is constructed from a plurality of compatible materials.

Some embodiments include an electric rotating machine having an end plate as described herein.

### BRIEF DESCRIPTION OF DRAWINGS

The teachings herein are explained in more detail in the following text with reference to figures, which show simple embodiments of the teachings:

FIG. 1 shows the prior art; and

FIG. 2 shows an end plate according to one exemplary embodiment of the teachings herein with a conical geometry.

### DETAILED DESCRIPTION

Some embodiments include a round end plate (1) for a housing of a rotating electric machine, having a device for receiving a bearing internally with an inner fastening circle (6), and means for fastening the end plate to the housing of the electric machine externally with an outer fastening circle (7), wherein the end plate has a geometry that is suitable for counteracting the deformation of the first natural frequency, because it overcomes the known flat and/or planar shape, or side, respectively, of the end plate by bending the end plate, in particular with the same or even a reduced mass and/or wall thickness of the end plate.

In some embodiments, the geometry is such that the planes of the device for receiving the bearing, for the one part, and the plane of the means for fastening the end plate to the housing, for the other part, are displaced with respect to one another in the direction of the axial length of the electric machine. In some embodiments, a geometry that is suitable for counteracting the deformation of the first natural frequency is a conical end plate geometry—as shown in FIG. 2.

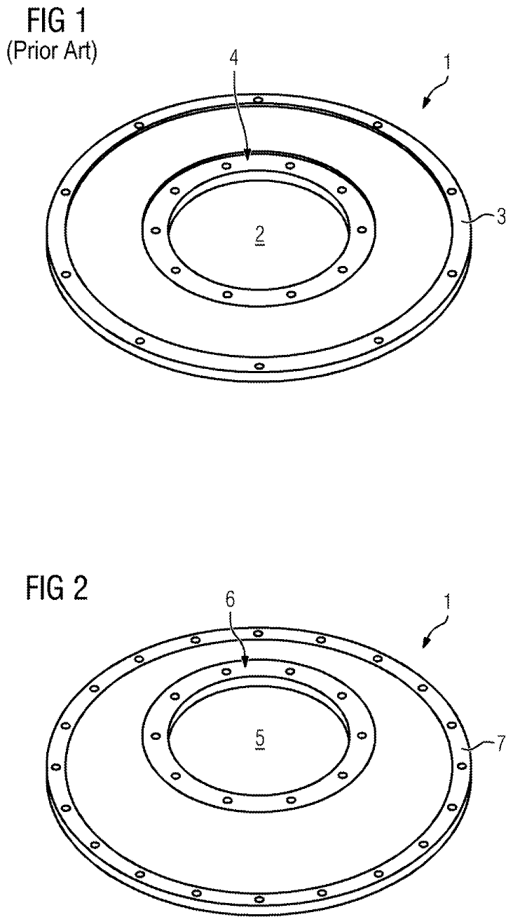

Given a correct and/or optimized design compared with the conventional plate-like end plates, as shown in FIG. 1, this can achieve a much greater bending stiffness with the same or even a lower mass. Tests have shown that in the case of a conical end plate geometry, the deformation of the first natural frequency is impeded in a targeted manner because said deformation is shifted into a higher frequency range. This effect has been found here for the first time and replaces the increase in plate thickness that is conventional in design practice and/or the introduction of load path-oriented ribbing structures as structural approaches for increasing the stiffness.

In some embodiments, the geometry that is suitable for counteracting the deformation of the first natural frequency is a conical geometry. For example, this is achieved in that the means for fastening the end plate to the housing of the electric machine have been axially displaced compared with the device for receiving the bearing. The size of the displacement corresponds to the deviation of the end plate from the flat geometry toward the conical geometry.

In this case, although the stability of the novel end plate can be enhanced by attaching a suitable rib structure on the underside and/or the side of the end plate forming the cone, the conical deformation, with the same and/or even a reduced wall thickness of the end plate, is also sufficient for achieving the stabilizing effect. This also results in the improvement, verified in tests, compared with conventional end plates that the conical end plate geometry achieves much greater bending stiffness with a lower mass, given a correct and/or optimized design compared with the conventional geometry variants.

In some embodiments, the device for receiving the bearing is simply a circular or, respectively, round cutout in the end plate.

In some embodiments, the means for fastening the end plate to the housing of the electric machine are screws with corresponding bores at the outer edge of the end plate. For example, an assembly was produced for the simulation, wherein the central disk was assumed to have the exemplary vibrating mass of 137 kg of weight. The tension stiffening action of the screws or, respectively, of the means for fastening was likewise taken into consideration in the simulation.

According to the prior art, as shown in FIG. 1, these means of the end plate are located, after incorporation in the electric machine, axially at the same height as the device for receiving the bearing, because the end plate according to the prior art is flat. In some embodiments, however, a conical rather than a flat geometry of the end plate is realized and accordingly, after incorporation in the electric machine, the means for fastening the end plate to the housing of the electric machine are not located axially at the same height as the device for receiving the bearing.

In some embodiments, the means for fastening externally to the end plate, on account of the maintenance of or even a reduction in the mass of the end plate, remain unchanged or even become smaller or lighter, respectively. As a result of an end plate having a geometry that is suitable for counteracting the deformation of the first natural frequency, a surprisingly high stiffness/mass ratio is achievable, such that, with a comparatively low mass, high stiffness of the end plate results.

On carrying out a number of exemplary simulations of different end plate designs, it was possible, in a first rough approximation, to determine the ratio of end plate mass to end plate stiffness, and there was a stiffness increased by more than 50%, with a reduced mass, compared with the known solid and/or ribbed geometries for end plates. The geometry, disclosed here for the first time, of the end plate can be realized with all conceivable materials for end plates; for example, the end plate can be made of metal, any metal alloys, such as steel, aluminum or cast iron, and, moreover, this geometry is also very suitable for lightweight production, that is to say with reinforced plastics.

In some embodiments, the end plate has a geometry that is suitable for counteracting the deformation of the first natural frequency and additionally has rib structures for increasing the stiffness. In some embodiments, the rib angles and/or the thickness of the end plate are adapted by means of computer-assisted geometry optimization.

In some embodiments, the end plate geometry that is suitable for counteracting the deformation of the first natural frequency is combined with fiber-reinforced construction materials. This geometry can be realized in common manufacturing processes and material classes of the fiber-reinforced construction materials. The geometry mentioned then results in a particularly greatly improved stiffness/mass ratio of the resulting end plate.

In some embodiments, the geometry of an end plate that is suitable for counteracting the deformation of the first natural frequency is optimized such that it is suitable, in the end plate, for shifting the loads in the material from shear loads to tensile/compressive loads. This optimization takes place preferably with computer assistance.

The construction materials that are particularly suitable here and are known to a person skilled in the art also comply for example with set demands with regard to vibration damping properties. Particularly suitable construction materials here, in addition to ceramic and metal materials, are also in particular the polymer-based fiber-composite materials, also known as polymer composites. These unite high structural stiffness, low specific weight and high vibration damping. The fiber-composite materials that are usable here can have a thermoplastic or thermosetting polymer matrix. They can have any desired fiber reinforcement, as are obtainable on the market for example as what are known as bulk and/or sheet molding compounds, also known as “BMC” and “SMC”, respectively.

In some embodiments, the abovementioned polymer materials are used with fiber reinforcement, for example glass fibers and/or carbon-fiber reinforcement. Carbon-fiber-reinforced material is particularly preferably used.

To produce the end plate, a very wide variety of materials, substances and/or reinforcement fibers can be present in combination. In some embodiments, the materials from which the end plate is constructed are constructed from mutually compatible materials—i.e. materials that are able to be combined without material-related drawbacks.

In some embodiments, ceramics and/or metals with fiber reinforcement are also used.

In some embodiments, use is also made in particular of sheet-molding-compound material. In this case, particular preference is given to this material being used in combination with the carbon-fiber reinforcement.

FIG. 1 shows the prior art; an end plate 1 that has a flat geometry, two flat sides or, respectively, wall sides can be seen. An oblique view is shown, showing the internally located device 2 for receiving the bearing—the latter not being illustrated—the means 3 for fastening the end plate to the housing of the electric machine externally and finally means 4 for fastening the bearing to the device 2 for receiving the bearing.

In FIG. 2, the same elements can be seen; the device 5 for receiving the bearing with, along an inner fastening circle 6, means for fastening the bearing being provided, which are present in a modified form compared with the prior art.

In some embodiments, the device 5 for receiving the bearing is not located on a plane with the outer circle 7 for fastening to the housing. Here, unlike in the end plate according to the prior art, as shown in FIG. 1, the inner screw-connection and/or connecting circle 6 does not lie on a plane with the outer fastening circle 7, on which the means for fastening the bearing to the housing are arranged, but in a manner axially displaced with respect thereto. The “axis” to which “axially” relates is in this case the axis of the rotating electric machine.

In some embodiments, an end plate as shown in FIG. 2 does not have a different wall thickness or material thickness than the flat and/or planar shape of the end plate according to the prior art, as shown in FIG. 1. Thus, on account of the cone shape, the end plate does not become heavier and nor does it have a greater wall thickness than the flat and/or planar shapes of the conventional end plates, as shown in FIG. 1.

Different end plate geometries made from the material carbon-fiber-reinforced sheet-molding composite were produced. The end plates differ in terms of the precise configuration of the ribbing and/or of the thickness of the cone. The different geometries were optimized with regard to the mass of the end plate, the mass of the motor and the natural frequency of the motor.

The ribbing was tested on one side on the end plate and on both sides. In simulations, a variety of types of ribbing were tested. The arrangements of the ribbing are designed in a variety of ways, for example as webs extending in a star shape with respect to the inner fastening circle. The webs extend preferably in a straight line, but can also be connected together, for example, by cross webs. In this case, the cross webs can in turn connect the longitudinally extending ribs, leading from the outer fastening circle to the inner one, in all possible angles to one another.

In some embodiments, the webs that form the ribs, have different shapes and/or masses. An alternative geometry variant is that the inner screw-connection and/or connecting circle 6 from FIG. 2 is longer than the outer connecting circle 7 in the axial direction, i.e. protrudes. Here too, however, a conical geometry is realized, which structurally provides the required stiffness increase.

Here, for the first time, an end plate for an electric rotating machine is presented, the geometry of which is suitable for counteracting the deformation of the first natural frequency. In particular, an end plate geometry is presented, the inner and outer fastening circle of which have been displaced axially with respect to one another.

What is claimed is:

1. An end plate for a housing of a rotating electric machine, the end plate comprising:
a device for receiving a bearing internally with an inner fastening circle;
fasteners for fastening the end plate to the housing of the electric machine externally with an outer fastening circle;
wherein the end plate has a geometry suitable for counteracting the deformation of the first natural frequency overcoming a flat and/or planar shape, or side, respectively, of the end plate by bending the end plate, with the same or a reduced mass and/or wall thickness of the end plate.

2. The end plate as claimed in claim 1, wherein the inner fastening circle and outer fastening circle are displaced axially with respect to one another.

3. The end plate as claimed in claim 1, comprising a conical shape.

4. The end plate as claimed in claim 1, further comprising ribbing on at least one side.

5. The end plate as claimed in claim 1, comprising a metal.

6. The end plate as claimed in claim 1, comprising a fiber-reinforced material.

7. The end plate as claimed in claim 6, wherein the fiber-reinforced material comprises a ceramic matrix.

8. The end plate as claimed in claim 6, wherein the fiber-reinforced material comprises a metal matrix.

9. The end plate as claimed in claim 6, wherein the fiber-reinforced material comprises a polymer matrix.

10. The end plate as claimed in claim 1, further, comprising ribbing on a first side, said ribbing extending from the outer fastening ring to the inner fastening ring.

11. The end plate as claimed in claim 1, further comprising ribbing with mutual cross-connections.

12. The end plate as claimed in claim 1, further comprising ribbing with webs with at least two differing masses.

13. The end plate as claimed in claim 1, wherein the end plate is constructed from a plurality of compatible materials.

14. An electric rotating machine comprising:
a housing; and
an end plate comprising:
a device for receiving a bearing internally with an inner fastening circle;
fasteners for fastening the end plate to the housing of the electric machine externally with an outer fastening circle;
wherein the end plate has a geometry suitable for counteracting the deformation of the first natural frequency overcoming a flat and/or planar shape, or side, respectively, of the end plate by bending the end plate, with the same or a reduced mass and/or wall thickness of the end plate.

15. (canceled)
